(19) United States
(12) Patent Application Publication
(10) Pub. No.: US 2026/0235434 A1
(43) Pub. Date: Aug. 13, 2026

(54) SCALE WEIGHT DISTRIBUTION USING AGRICULTURAL CHARACTERISTIC INDEX FOR YIELD MAPPING AND SENSOR CALIBRATION

(71) Applicant: Deere & Company, Moline, IL (US)

(72) Inventors: Ryan C. RUSSELL, Orion, IL (US); Federico PARDINA-MALBRAN, Fort Collins, CO (US); Corey A. AKERS, Highlands Ranch, CO (US); Nathan R. VANDIKE, Geneseo, IL (US)

(21) Appl. No.: 19/051,964

(22) Filed: Feb. 12, 2025

(51) Int. Cl. G01G 19/08; A01D 41/127; A01D 90/12

(52) U.S. Cl. CPC G01G 19/08; A01D 41/127; A01D 90/12

(57) ABSTRACT

A yield characteristic is sensed and correlated to a harvested area. A agricultural characteristic index is obtained for the harvested area, and the yield characteristic is distributed across the harvested area based upon the agricultural characteristic index. The distributed yield characteristic can be used for mapping. The distributed yield characteristic can also be used for calibrating a yield sensor.

### FIELD OF THE DESCRIPTION

The present description relates to agricultural machines. More specifically, the present description relates to distributing yield characteristic values across a harvest area using agricultural characteristic index data.

### BACKGROUND

There are many different types of agricultural harvesters. As such harvesters move through a field, the harvesters engage crop to be harvested, sever that crop, and then separate grain from residue. The grain is moved to a clean grain tank on the harvester while the residue is discharged from the harvester.

When the clean grain tank is full, the agricultural harvester often unloads the harvested material into a material transfer vehicle, such as a tractor-pulled grain cart. The material transfer vehicle then transfers the harvested material to a haulage vehicle (such as a semi-truck) or another container. The material transfer vehicle unloads the harvested material into the haulage vehicle or other container.

It is not uncommon for the harvested material to be weighed. For instance, the harvester may have load cells or other types of scales in the clean grain tank to weigh the amount of harvested material. The material transfer vehicle may also have a scale. For instance, some grain carts have scales or load cells that are used to detect the weight of material in the grain cart. Further, some semi-trailers or other containers have scales that can be used to weigh the harvested material as well.

The discussion above background is merely provided for general background information and is not intended to be used as an aid in determining the scope of the claimed subject matter.

### SUMMARY

A yield characteristic is sensed and correlated to a harvested area. Agricultural characteristic index data is obtained for the harvested area, and the yield characteristic is distributed across the harvested area based upon the agricultural characteristic index data. The distributed yield characteristic can be used for mapping. The distributed yield characteristic can also be used for calibrating a yield sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a partial pictorial, partial block diagram view of an agricultural system.

FIG. 2 is a pictorial illustration depicting the distribution of a yield characteristic (e.g., weight) across a harvested area using a vegetative index value.

FIG. 3 is a pictorial illustration showing use of the distributed yield characteristic in generating a yield map.

FIG. 4 is a pictorial illustration showing the distribution of a yield characteristic, accounting for coverage.

FIG. 5 is a pictorial illustration showing use of the distributed yield characteristic for sensor training/calibration.

FIG. 6 is a block diagram showing one example of a yield characteristic distribution and control system.

FIG. 7 is a flow diagram illustrating one example of the operation of the yield characteristic distribution and control system.

FIG. 8 is a flow diagram showing one example of a calibration operation.

FIG. 9 is a flow diagram showing one example of identifying a harvest area corresponding to an aggregated yield characteristic.

FIG. 10 shows one example of the agricultural system deployed in a remote server architecture.

FIGS. 11, 12, and 13 show examples of mobile devices that can be used in the architectures and systems shown in other FIGs.

FIG. 14 is a block diagram showing one example of a computing environment that can be used in the architectures and systems shown in other FIGs.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. It is fully contemplated that the features, components, and/or steps described with respect to one example may be combined with the features, components, and/or steps described with respect to other examples of the present disclosure.

Agricultural harvesters may have yield sensors that sense a characteristic indicative of yield during the harvesting operation. For instance, an agricultural harvester may have a mass flow sensor in a clean grain elevator. The clean grain elevator moves clean grain from a cleaning subsystem (or cleaning shoe) to the clean grain tank. However, the output of the yield sensor cannot easily be attributed back to the geographical location from which the grain was harvested.

One reason that this type of attribution is difficult is that there are system delays and other variables which make it difficult to determine which portion of the field produced the harvested grain. By way of example, as the header of an agricultural harvester engages crop, the crop is severed and moved along the header toward the center of the header where the severed material is moved back through a feeder house into the threshing subsystem. The severed material is then threshed and cleaned by the cleaning subsystem before the clean grain elevator moves the harvested material to the clean grain tank. Therefore, there is a significant time delay between when the crop is severed at the header and when the resulting grain is passing through the clean grain elevator and sensed by the mass flow sensor. Also, the time delays for crop engaged by the outer ends of the header are greater than the time delays for crop engaged by the center of the header. Further, the yield may vary across the width of the header. This makes it even more difficult to determine the geographic location that produced the grain sensed by the mass flow sensor in the clean grain elevator.

As discussed above, during the harvesting operation, it is not uncommon for there to be an opportunity to measure an accurate yield characteristic indicative of yield. For example, it is often possible to weigh the harvested material during the harvesting operation. By way of example, an agricultural harvester may have a scale or load cell or other weighing mechanism in the clean grain tank so that harvested material can be weighed as the harvested material is collected in the clean grain tank. Similarly, the material transfer vehicle (the tractor-pulled grain cart) may have a scale. For example, a grain cart may have one or more load cells or scales so that harvested material that is loaded into the grain cart may be weighed. Further, semi-trailers or other containers may have scales that can be used to weigh the material loaded into the semi-trailer or container. The scale measurements are normally very accurate and are also highly indicative of, and correlated to, yield. However, it is currently difficult to attribute the weight of harvested material measured by one of the scales to a geographic location from which the crop was obtained.

Therefore, the present description describes a system which obtains a weight measurement (or other yield characteristic measurement) of harvested material and identifies a harvest area from which that material was harvested. The harvest area can be identified as an area over which the agricultural harvester performed a harvesting operation since the agricultural harvester was last unloaded. A set of agricultural characteristic index values (such as vegetative index values) are then obtained for that harvest area. The weight of the harvested material (or other yield characteristic of the harvested material) is then distributed over the harvest area based upon the agricultural characteristic index values for the harvest area. The distributed weight values (or distributed yield characteristic values) can then be used to generate a yield map and/or to perform calibration of the on-board yield sensor on the agricultural harvester.

It will be noted that the present description proceeds primarily with respect to the agricultural characteristic index values (which are geolocated values) being vegetative index values, but this is for the sake of example only. The present description could just as easily proceed with respect to other agricultural characteristic index values. Such other agricultural characteristic index values may include such values as historical yield or other historical information corresponding to the harvest area, biomass index values generated from the vegetative index values or from a perception sensor or from a sensor that senses biomass during a prior pass of the agricultural harvester through the field, soil or terrain index values, signal values from a mass flow sensor on the agricultural harvester sampled at different geographic locations in the harvest area, fertilizer or other commodity application index values, crop height index values (such as measured with a LIDAR sensor or another sensor), planting-related index values (such as plant population, emergence, skips, doubles), pre-plant residue index values, weed index values, sprayer index values, other crop property index values, among others. Also, combinations of these and/or other agricultural characteristic index values can be used to distribute the yield characteristic, instead of a single agricultural characteristic index value.

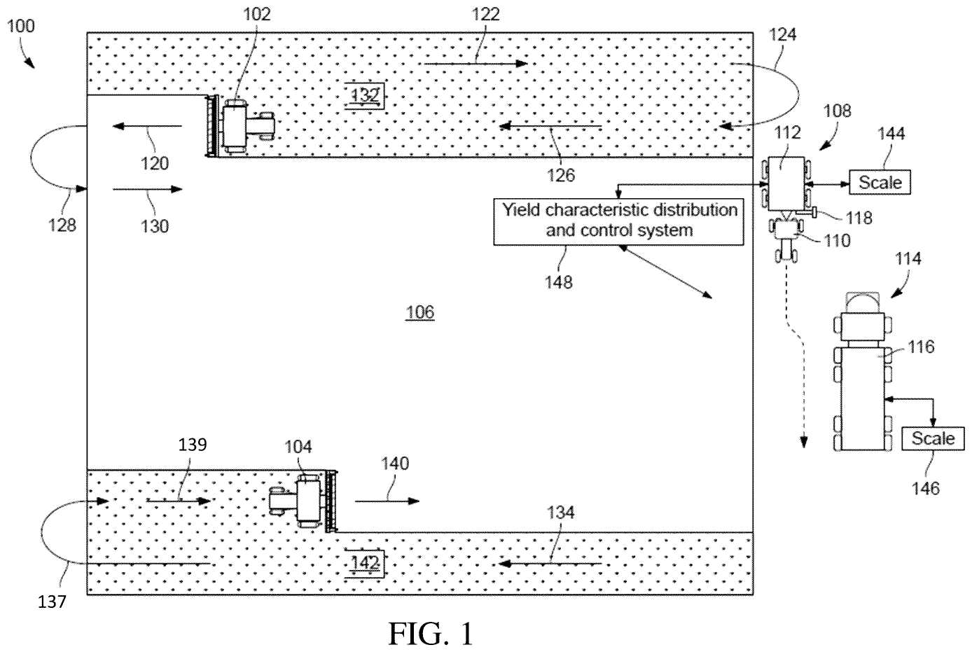

FIG. 1 is a partial pictorial, partial block diagram of one example of an agricultural system 100 in which a plurality of harvesters 102, 104 are harvesting material from a field 106. For instance, FIG. 1 shows that harvester 102 made a first pass in the direction indicated by arrow 122, then made a headland turn indicated by arrow 124 and followed a second pass indicated by arrow 126. Harvester 102 is moving in the direction indicated by arrow 120 toward another headland turn indicated by arrow 128 to make another pass indicated by arrow 130. Therefore, as illustrated in FIG. 1, harvester 102 has harvested material from the dotted harvest area (or harvest area) 132.

Similarly, FIG. 1 shows that harvester 104 made a first pass indicated by arrow 134, made a headland turn indicated by arrow 137, and began a second pass indicated by arrow 138. Harvester 104 continues to move along the second pass in the direction indicated by arrow 140. Therefore, the area that has been harvested by harvester 104 is the dotted area (or harvest area) 142.

A material transfer vehicle 108 includes a propulsion vehicle (such as a tractor 110) and a grain cart 112. When a clean grain tank in one of the harvesters 102, 104 is full or at another desired fill level (for the sake of the present discussion, it will be assumed that harvester 102 is the harvester that has a clean grain tank that is full or at another desired fill level), then material transfer vehicle 108 moves adjacent the harvester 102 and the harvester 102 unloads harvested material from its clean grain tank into the grain cart 112. Material transfer vehicle 108 then moves back toward a haulage vehicle 114 (which in the present example is a semi-truck 114 with a semi-trailer 116) and unloads the material through a spout or auger 118 from grain cart 112 into semi-trailer 116. It will be appreciated that, in some examples, material transfer vehicle 108 can wait to unload at haulage vehicle 114 until material transfer vehicle 108 has received grain from another harvester 104 or until material transfer vehicle 108 receives additional material from harvester 102 in a subsequent unload operation. These and other examples are contemplated herein.

In the example shown in FIG. 1, the agricultural system 100 may have devices for sensing yield characteristics, such as crop weight. For instance, there may be one or more load cells or scales in the clean grain tank of the agricultural harvesters 102, 104. Such load cells or scales may sense the weight of material in those agricultural harvesters. In another example, grain cart 112 may be fitted with a scale 144. Scale 144 may be implemented as a load cell in the axles of grain cart 112, or in another configuration. Semi-trailer 116 may also have one or more scales 146 that are disposed to sense the weight of material in semi-trailer 116. Further, there may be an external scale that is external to the machines illustrated in FIG. 1. An external scale may be deployed, for instance, so that material transfer vehicle 108 can move into position on the scale so that its contents can be weighed. Other scales are contemplated herein as well.

Further, a scale is merely one example of a sensor that can be used to detect a yield characteristic indicative of yield. Other sensors may sense volume, density, mass, mass flow, and/or other yield characteristics. The present discussion will proceed with respect to the yield characteristic being weight that is detected by a scale.

While the weight or other yield characteristic measured by scales 144, 146, or other yield characteristic sensors may be accurate representations of yield, it can be very difficult to attribute that yield to different geographic locations in field 106, because the scales or other yield characteristic sensors are not deployed on the agricultural harvesters 102, 104. Further, even if the scales or other yield characteristic sensors are deployed on the agricultural harvesters 102, 104, it can be difficult to know where the measured yield came from in the field, because of system delays, processing delays, and other complications in the harvesting operation.

Therefore, in one example, yield characteristic distribution and control system 148 is provided in agricultural system 100. Yield characteristic distribution and control system 148 receives the weight of harvested material measured by one or more of the scales 144, 146 and identifies the harvest area from which that harvested material was obtained. For instance, when grain cart 112 is loaded with harvested material from agricultural harvester 102, then yield characteristic distribution and control system 148 identifies the harvest area 132 that was harvested by agricultural harvester 102 since agricultural harvester 102 was last unloaded. That harvest area 132 thus corresponds to the material that was loaded into grain cart 112. Yield characteristic distribution and control system 148 then obtains a georeferenced set of agricultural characteristic values (such as vegetative index values) for harvest area 132. The present description will proceed primarily with respect to the georeferenced agricultural characteristic values being vegetative index values, but this is for example only and other georeferenced agricultural characteristic values could be used as well. For instance, yield characteristic distribution and control system 148 can obtain a vegetative index map that maps vegetative index values to different geographic locations in harvest area 132. Based upon those geo-referenced vegetative index values, yield characteristic distribution and control system 148 distributes the measured weight of harvested material to the different geographic locations in harvest area 132.

It can also happen that material transfer vehicle 108 receives material from both harvesters 102 and 104 before unloading into semi-trailer 116. In such a scenario, yield characteristic distribution and control system 148 maintains a record of the weight of material it received from each agricultural harvester 102, 104, and the harvest area corresponding to that material (e.g., harvest area 132 corresponds to the material received from agricultural harvester 102, and harvest area 142 corresponds to the material received from agricultural harvester 104). Thus, yield characteristic distribution and control system 148 can then obtain vegetative index values for both harvest areas 132 and 142 and attribute the weight of harvested material obtained from each agricultural harvester 102, 104, to the corresponding harvest area 132, 142 based upon the vegetative index values for those harvest areas 132, 142.

In another example, the weight of material transferred from each agricultural harvester 102, 104 to material transfer vehicle 108 may not be separately known. One example may be where the collective amount of material transferred from both of the agricultural harvesters 102, 104 is not weighed until after both agricultural harvesters 102, 104 have unloaded material into material transfer vehicle 108. This may occur, for instance, when the transferred material is first weighed by scale 146 on haulage vehicle 116, or by another scale located elsewhere. In such an example, the weight of material transferred specifically from harvester 102 and the weight of material transferred specifically from agricultural harvester 104 are not separately known. In that case, the collective weight of material is distributed over both harvest areas 132, 142 based on the vegetative index values for harvest areas 132, 142.

The weight values are thus distributed to different geographic locations in the different harvest areas. These values represent an accurate, distributed yield so that a highly accurate yield map can be obtained. Similarly, such values can be used to calibrate the yield sensors on the agricultural harvesters 102, 104. Distributing the weight values based upon the vegetative index values to obtain a yield map and using the distributed values to calibrate the on-board yield sensors on the agricultural harvesters 102, 104 will now be described in more detail.

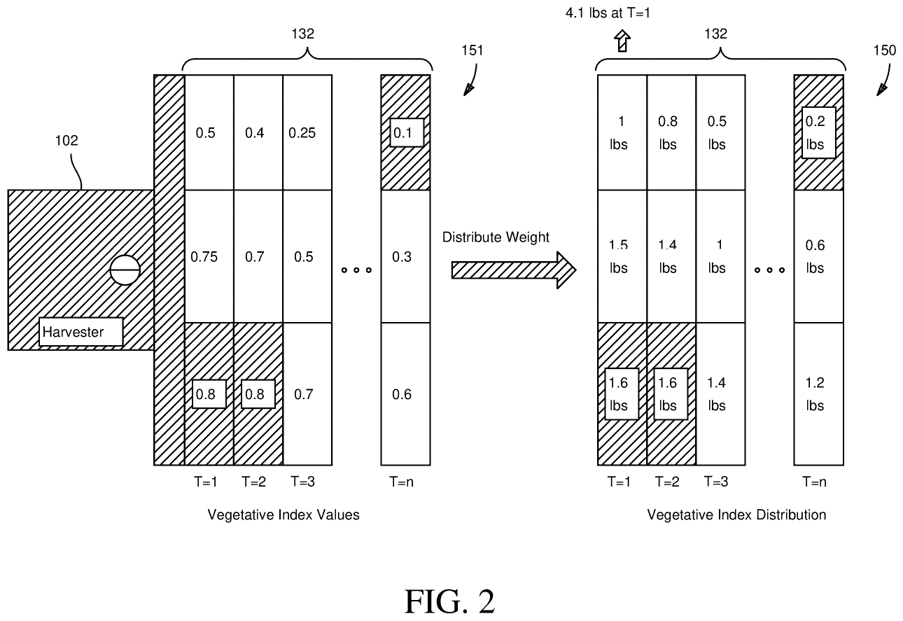

FIG. 2 is a pictorial illustration representing one example of how a weight value is distributed over a harvest area, given a set of vegetative index values. In FIG. 2, it is assumed that agricultural harvester 102 harvested 20,000 pounds of grain from a harvest area 132. FIG. 2 also shows that, as generally indicated at 151, harvest area 132 has been broken into a plurality of cells, where each cell corresponds to a geographic area in harvest area 132 and contains a corresponding vegetative index value. These cells are grouped into columns corresponding to different timestamp values. The timestamp values are indicated as T=1, T=2, T=3, . . . , T=N. Each time stamp value thus corresponds to an area of harvest area 132 that was covered by the agricultural harvester 102 since the last time stamp value. At time stamp value T=1, the top cell in harvest area 132 has a vegetative index value of 0.5. The middle cell has a vegetative index value of 0.75, and the lower cell has a vegetative index value of 0.8. Based upon the vegetative index values in the cells of harvest area 132, yield characteristic distribution and control system 148 distributes the 20,000 pounds of grain among the various cells to obtain a weight distribution generally indicated by 150. Therefore, the upper cell at timestamp T=1 is attributed 1 pound of grain. The middle cell is attributed 1.5 pounds of grain, and the lower cell is attributed 1.6 pounds of grain. The total grain harvested over the portion of harvest area 132 covered at timestamp T=1 is thus 4.1 pounds (1 lb+1.5 lb+1.6 lb). The 20,000 pounds is distributed in a similar way over each of the different cells, at each time interval represented by the different timestamps.

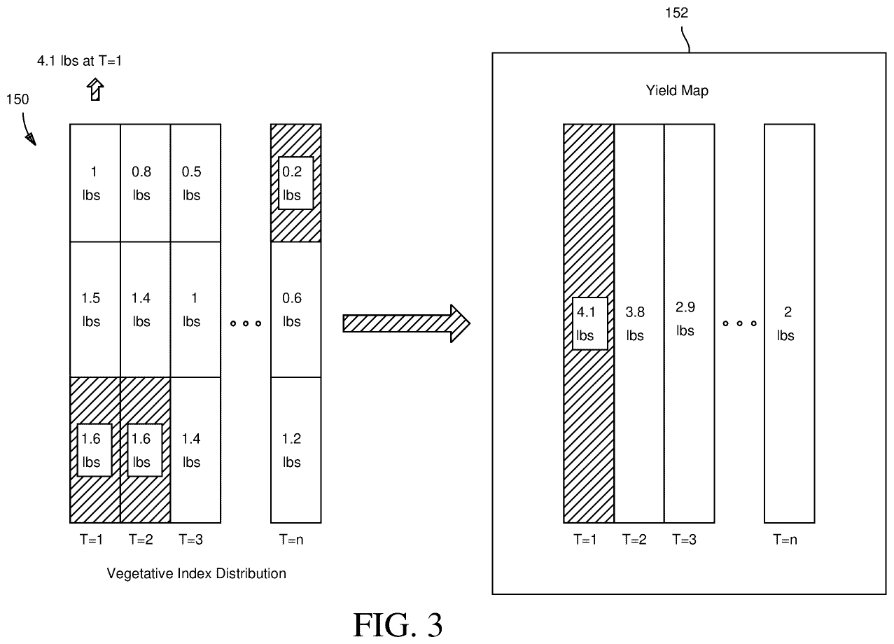

FIG. 3 is similar to FIG. 2, and similar items are similarly numbered. However, in FIG. 3, a yield map 152 is generated for harvest area 132, based on the distribution 150, but having a lower resolution than the weight distribution 150. In the yield map 152 illustrated in FIG. 3, the three different cells for each time interval are combined to represent a single larger geographic area. Therefore, the weight for all three cells at each time interval is combined into a weight for a single cell, representing a corresponding geographic area in harvest area 132, and illustrated as yield map 152. The geographic portion of harvest area 132 covered during the first time interval is attributed 4.1 pounds of grain. The geographic portion of harvest area 132 covered during the second time interval is attributed 3.8 pounds of grain (0.8 lb+1.4 lb+1.6 lb). The geographic portion of harvest area 132 covered during the third time interval is attributed 2.9 pounds of grain (0.5 lb+1 lb+1.4 lb), and the geographic portion of harvest area 132 covered during the Nth time interval is attributed 2 pounds of grain (0.2 lb+0.6 lb+1.2 lb).

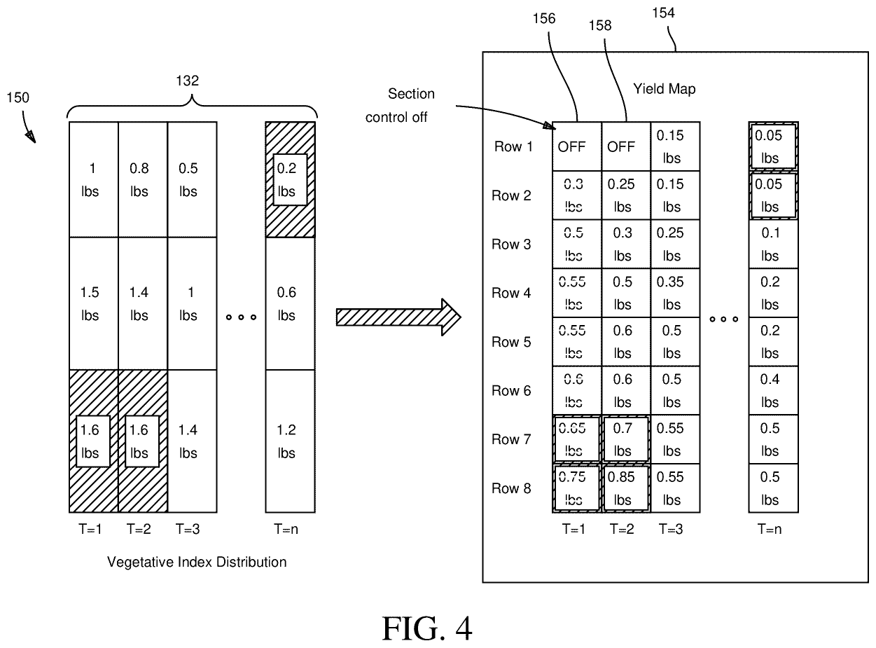

FIG. 4 is similar to FIG. 3, and similar items are similarly numbered. However, FIG. 4 shows that, instead of generating yield map 152 that has a lower resolution than the cells in distribution 150, yield characteristic distribution and control system 148 generates a yield map 154 that has a higher resolution than the cells shown in distribution 150. Yield map 154 is broken into cells, at each time interval, where each cell corresponds to the geographic location of a harvested row. Thus, the distribution of material is distributed on a per-row basis.

Further, there may be scenarios where the agricultural harvester 102 travels over geographic locations that do not have crop to be harvested. Therefore, no yield should be attributed to those areas, even though they may technically reside within the harvest area that the agricultural harvester traveled over since the agricultural harvester was last unloaded. For instance, agricultural harvester 102 may travel over areas that have already been harvested, areas where no crop is planted, passable non-crop areas, or areas where no crop yields should be attributed for other reasons. In that case, yield characteristic distribution and control system 148 accounts for those areas and does not attribute any of the yield to those areas, but instead distributes the harvested crop over the remaining portions in the harvest area.

In FIG. 4, for instance, there are two cells 156 and 158 that correspond to geographic locations where no crop was harvested. In one example, the geographic locations corresponding to cells 156 and 158 in yield map 154 were harvested during the previous pass of the agricultural harvester 102. In another example, those geographic locations may reside in a waterway, or in another passable non-crop area where no crop was planted. Yield characteristic distribution and control system 148 detects that no yield should be attributed to cells 156 and 158. Such detection may be accomplished in different ways. For instance, system 148 or another system may detect that the portion of the header traveling over cells 156 and 158 is traveling over a non-crop area. Such detection can be performed by processing a map of the non-crop areas in the field, using a perception sensor or another sensor to sense that there is no crop in cells 156 and 158. Non-crop areas can be detected using other field maps, using other on-board or off-board sensors, or in other ways as well. When cells 156 and 158 have been detected as corresponding to non-crop areas, then no yield is attributed to those cells. Instead, the weight of the harvested crop is distributed over the other cells in yield map 154, excluding cells 156 and 158.

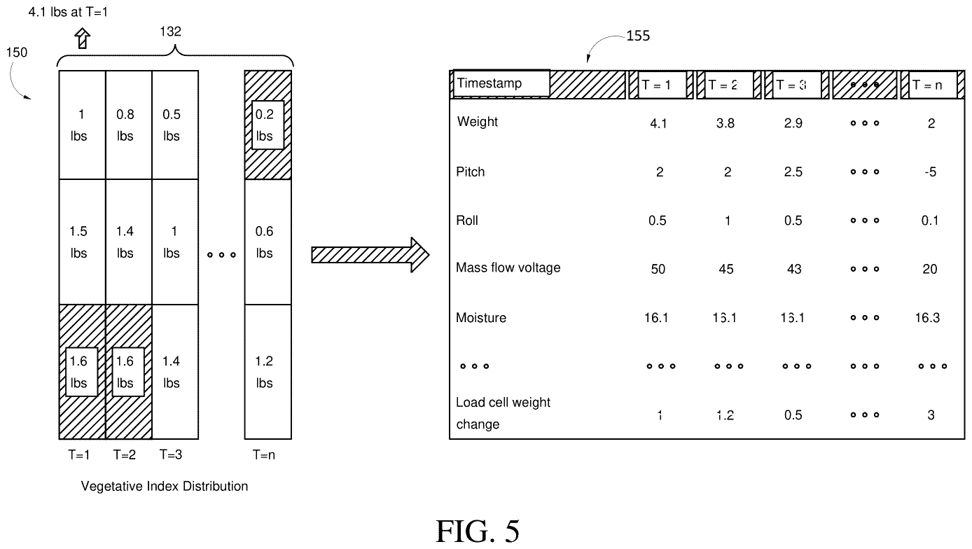

As briefly discussed above, the distribution 150 can also be used to train yield sensors onboard agricultural harvesters 102, 104. In one example, in generating a yield sensor signal, the yield sensors consider other characteristics such as the orientation (e.g., pitch and roll) of the harvester 102, the output from a mass flow sensor in the clean grain elevator or located elsewhere in the agricultural harvester 102, the crop moisture, the weight generated by a load cell in the clean grain tank or elsewhere on the agricultural harvester 102, and/or any of a wide variety of other environmental characteristics, machine characteristics, crop characteristics, etc. Therefore, in one example, the distributed weight of harvested material at each time interval can be combined with the other characteristics and used as training data to train the on-board yield sensors. FIG. 5 shows one example of this.

In FIG. 5, the weight distributions 150 for each time interval are recorded along with the other values that are used by the on-board yield sensor in table 155. Thus, at time interval T=1, the distributed weight value of 4.1 pounds is correlated to a pitch value of 2.0, a roll value of 0.5, a voltage reading from a mass flow sensor of 50, a crop moisture value of 16.1, and a load cell weight change value generated from a load cell in the clean grain tank of harvester 102 of 1. The same types of data are generated and stored for each time interval. That data can then be used for regression training, or other training, of the on-board load sensors.

For example, assume that the on-board yield sensor uses equation 1 below to calculate the instantaneous yield in pounds of harvested crop for a given time interval:

$$lbs = a 1 ⋆ pitch + a 2 ⋆ roll + a 3 ⋆ massFlowVoltage + a 4 ⋆ moisture + … + an ⋆ LoadCellWeightChange + b \qquad Eq 1$$

where,
a1-an are coefficients that are trained;
b is a trained constant;
pitch is the pitch value;
roll is the roll value;
massFlowVoltage is the voltage output by the on-board mass flow sensor;
moisture is the moisture value; and
LoadCellWeightChange is the change in the value output by the on-board load cell.

Assume further that equation 2 below can be used to calculate or compute the weight of an entire grain cart load of material by summing over the weights corresponding to each time interval:

$$Eq . 2$$

$$\begin{matrix}Sum ( lbs ) = \begin{matrix}s um ( a 1 ⋆ pitch + a 2 ⋆ roll + a 3 ⋆ massFlowVoltage + \\ a 4 ⋆ moisture + … + an ⋆ LoadCellWeightChange + b )\end{matrix} \\ = \begin{matrix}a 1 ⋆ sum ( pitch ) + a 2 ⋆ sum ( roll ) + a 3 ⋆ sum ( massFlowVoltage ) + \\ a 4 ⋆ sum ( moisture ) + … + an ⋆ sum ( loadCellWeightChange ) + \\ b ⋆ n ( timestamps ) = Grain Cart Load\end{matrix}\end{matrix}$$

Using equations 1 and 2 above, the weight of an entire grain cart load can be distributed over time to regress or train the on-board yield sensors over each time interval.

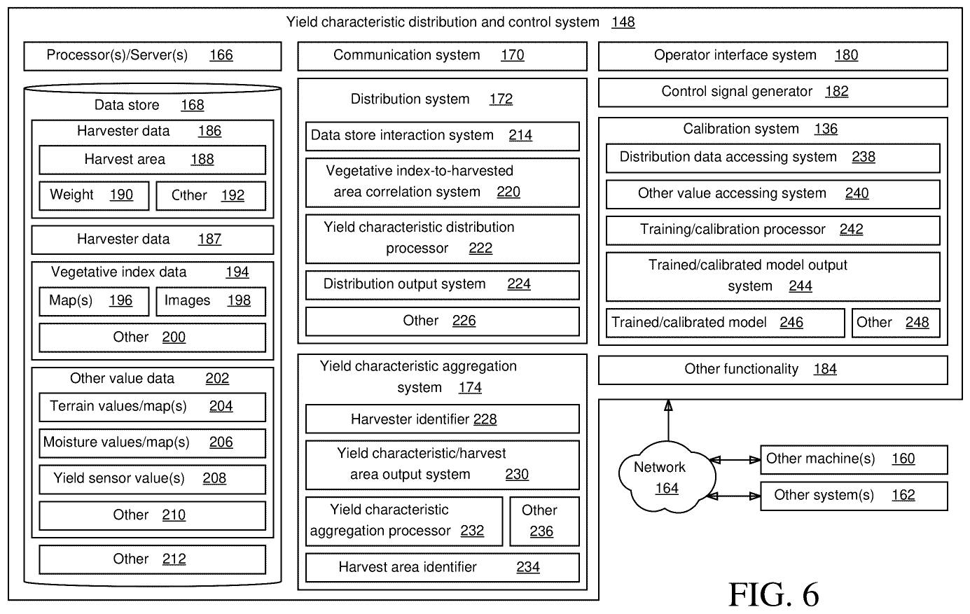

FIG. 6 is a block diagram showing one example of yield characteristic distribution and control system 148 in more detail. It will be noted that the items in yield characteristic distribution control system 148 can all be located at a single location (such as on tractor 110, on one of the harvesters 102, 104, on haulage vehicle 114, on a remote computing system, or elsewhere). The items in yield characteristic distribution and control system 148 can also be distributed so that some items are located at one location or in one system while other items are located at a different location or in a different system. The items in yield characteristic distribution and control system 148 are shown as a single system in FIG. 6 for the sake of example only. FIG. 6 also shows that system 148 can communicate with other machines 160 and/or other systems 162 over network 164. Other machines can be other machines performing harvesting operations in field 106 or elsewhere, haulage vehicle 114, material transfer vehicle 108, other tender vehicles, or other machines. Other systems 162 can be farm manager systems, vendor systems, cloud-based systems, or other systems. Network 164 can be a local area network, a wide area network, a near field communication network, a Wi-Fi or Bluetooth network, a cellular communication network, or any of a wide variety of other networks or combinations of networks.

In the example shown in FIG. 6, yield characteristic distribution and control system 148 includes one or more processors or servers 166, data store 168, communication system 170, distribution system 172, yield characteristic aggregation system 174, calibration system 136, operator interface system 180, control signal generator 182, and/or any of wide variety of other functionality 184. Data store 168 can include harvester data records 186-187. An example of harvester data record 186 can include harvest area data 188, weight data 190, and other data 192. Data store 168 can also include vegetative index data 194 which, itself, can include vegetative index maps 196, vegetative index satellite images or other images 198, and/or other vegetative index data 200. Data store 168 can also include other value data 202 which may be data used by on-board yield sensors to perform on-board yield sensing. Thus, other value data 202 can include terrain values and/or maps 204, moisture values and/or maps 206, yield sensor values from the on-board yield sensors 208, and other data 210. Data store 168 can also include a wide variety of other data 212 as well.

Communication system 170 can facilitate the communication of items in system 148 with one another and can also facilitate communication over network 164. Therefore, communication system 170 may be a controller area network (CAN) bus and bus controller, a cellular communication system, a near field communication system, a Bluetooth or Wi-Fi communication system, a wide area network communication system, a local area network communication system, or any of a wide variety of other communication systems or combinations of systems.

Operator interface system 180 can include a wide variety of different types of operator interface mechanisms, such as a steering wheel, a joystick, pedals, linkages, levers, buttons, and/or a display screen that outputs information to an operator of one of the vehicles in agricultural system 100, or of another machine. Operator interface system 180 can also include operator interface mechanisms that receive input from an operator through such things as links, icons, buttons, drop-down menus, etc. The display screen may be a touch sensitive screen and be mounted in tractor 110, in one of the agricultural harvesters 102, 104, in haulage vehicle 114, or on a mobile device or elsewhere. Operator interface system 180 can include a microphone and speakers (such as where speech-enabled operations are supported), and/or any other mechanisms that provide audio, visual, and/or haptic outputs to an operator or receive inputs from an operator.

Distribution system 172 includes data store interaction system 214, vegetative index-to-harvested area correlation system 220, yield characteristic distribution processor 222, distribution output system 224, and other items 226. Yield characteristic aggregation system 174 includes harvester identifier 228, yield characteristic/harvest area output system 230, yield characteristic aggregation processor 232, harvest area identifier 234, and other items 236. Calibration system 136 includes distribution data accessing system 238, other value accessing system 240, training calibration processor 242, trained/calibrated model output system 244, trained/calibrated model 246, and other items 248. Before describing the operation of yield characteristic distribution and control system 148 in more detail, a description of some of the items in system 148, and their operation, will first be provided.

Harvester data records 186-187 can include a variety of different information. Harvest area information 188 defines the harvest area over which the agricultural harvester traveled since it was last unloaded. Harvest area information 188 can be generated by a position sensor on the agricultural harvester, such as a Global Navigation Satellite System (GNSS) receiver, a dead reckoning system, a cellular triangulation system, or another position sensing system that outputs the location of the agricultural harvester in a global or local coordinate system. By tracking the route of the agricultural harvester using the positioning system, between unload operations, and by knowing the width of the header of the agricultural harvester, and by accounting for non-crop areas, the harvest area data 188 can be determined and used to define the harvest area that was covered by the agricultural harvester since it was last unloaded. Weight data 190 identifies the weight of material received from the agricultural harvester corresponding to harvest area data 188. Weight 190 can be obtained from any of the scales 144, 146 or in other ways. Harvester data record 187 may include similar data to harvester data record 186, but corresponding to a different harvester, a different harvest area, or a different unload operation, etc.

Vegetative index data 194 is illustratively a set of geo-referenced vegetative index values corresponding to the field 106 being harvested. Vegetative index data 194 can be provided in the form of a vegetative index map 196, satellite images or other images 198 from which geo-referenced vegetative index data can be computed, or other data sources 200.

Other value data 202 includes values for other data that can be used to train the on-board yield sensors on an agricultural harvester, such as the other data shown in FIG. 5 above, in addition to the weight of the harvested material. Thus, other value data 202 can include terrain values or maps 204 that may identify the pitch and roll of the agricultural harvester at different geographic locations. The terrain values 204 may be sensed with a sensor (such as an accelerometer, an inertial measurement unit, RADAR sensor, LIDAR sensor, ground contact sensor such as a header height sensor, etc.) or determined from a terrain map or obtained in other ways. Moisture values/maps 206 identify crop moisture for the crop being harvested. Moisture values/maps 206 may be sensed with a moisture sensor (such as a capacitive moisture sensor or another sensor that senses the moisture of the crop), or read from a map where a crop moisture map has been generated, or obtained in other ways. Yield sensor values 208 correspond to the values generated by the on-board yield sensor on the agricultural harvester, such as the mass flow sensor described above with respect to FIG. 5 or another sensor.

Yield characteristic aggregation system 174 can generate records and store the records in data store 168 or at another location. Those records can be used in scenarios in which, for example, material transfer vehicle 108 is loaded with grain from a plurality of different agricultural harvesters 102, 104, before grain cart 112 is unloaded into haulage vehicle 114. Thus, harvester identifier 228 identifies a particular agricultural harvester 102, 104 that is about to unload, or is unloading, harvested material into grain cart 112. The yield characteristic aggregation processor 232 aggregates or otherwise identifies the weight of material transferred to grain cart 112 from the identified agricultural harvester. Thus, yield characteristic aggregation processor 232 may identify the change in weight measured by scale 144 between a time before grain is unloaded by the identified harvester into grain cart 112 and the time after the grain is unloaded into grain cart 112 by the identified agricultural harvester. This change in weight will correspond to the weight of material received from that agricultural harvester during that unload operation.

Harvest area identifier 234 identifies the harvest area corresponding to the material loaded into grain cart 112. For instance, if grain cart 112 is loaded with material from agricultural harvester 102, that material is weighed by scale 144 and tracked by yield characteristic aggregation processor 232 and the harvest area from which that grain was harvested is identified by harvest area identifier 234. In one example, the harvest area may be transmitted by agricultural harvester 102 and received and stored by harvest area identifier 234. In another example, the locations of agricultural harvester 102 when harvester 102 started harvesting in the harvest area after a previous unload operation and when harvester 102 finished harvesting in the harvest area and unloaded its grain into grain cart 112, can be sent to harvest area identifier 234 along with the route or path followed by harvester 102, and harvest area identifier 234 can compute the harvest area based upon that information or based on other information.

Yield characteristic/harvest area output system 230 correlates the weight of harvested material (output by yield characteristic aggregation processor 232) to the harvest area (output by harvest area identifier 234) and generates an output indicative of the weight of material harvested from that particular harvest area. The weight may be identified in pounds while the harvest area may be identified by a geographic boundary or a set of geographic coordinates corresponding to the harvest area or in other ways. Yield characteristic/harvest area output system 230 can output and store the identity of the harvest area, along with the weight of material harvested from that harvest area, as harvester data 186 in data store 168. This type of information can be generated and stored in data store 168 for each different agricultural harvester, for each different harvest area, etc.

Distribution system 172 accesses the weight of harvested material and the corresponding harvest area (such as from data store 168) and obtains geo-referenced vegetative index values 194 for the corresponding harvest area. Distribution system 172 distributes the weight of material harvested from that harvest area over that harvest area based upon the geo-referenced vegetative index values to obtain a weight distribution such as distribution 150 discussed elsewhere herein. It will be noted that where another yield characteristic is used, other than weight, then that yield characteristic is distributed over the harvest area based on the geo-referenced vegetative index values.

Thus, data store interaction system 214 interacts with data store 168 or another data store to obtain harvester data 186, such as harvest area data 188 that geographically identifies a harvest area and weight data 190 that identifies the weight of material harvested from the identified harvest area. Data store interaction system 214 also obtains geo-referenced vegetative index values 194 for the identified harvest area.

Vegetative index-to-harvested area correlation system 220 then correlates the geo-referenced vegetative index values 194 to the harvest area and yield characteristic distribution processor 222 distributes the harvested weight 190 over the harvest area based upon the geo-referenced vegetative index values 194. Distribution output system 224 generates an output indicative of the weight distribution. For instance, the output can be a weight distribution similar to weight distribution 150 shown in FIGS. 2-4. The output can be a yield map such as map 152 in FIG. 3 or map 154 in FIG. 4, or another type of yield map. The distribution output may take other forms as well.

Control signal generator 182 can generate a control signal based upon the distribution output. The control signal can be used to control a mapping system to generate a yield map. The control signal can be used to control communication system 170 to communicate the distribution output to other machines 160 and/or other system 162 over network 164. The control signal can be used to control calibration system 176 to perform a calibration corresponding to the on-board sensors on an agricultural harvester. The control signal can be used to control operator interface system 180 to generate an output indicative of the distribution output for observation or use by an operator. The control signal can be used to perform other operations as well.

Calibration system 136 can use the distribution data to calibrate the on-board yield sensors or other yield sensors in agricultural system 100. Distribution data accessing system 238 receives the distribution output from distribution system 172, or retrieves the distribution from a data store, or obtains the distribution in other ways. Other value accessing system 240 obtains the other value data 202 corresponding to the harvest area over which the yield distribution has been made. For instance, the other value data 202 can include the data shown in FIG. 5 for each time interval over which the harvest area was harvested. Training/calibration processor 242 uses the data to train the on-board yield sensor. For instance, as discussed above, the training/calibration processor 242 can perform regression training to train the coefficients and constants in equations one and two above. Training/calibration processor 242 can perform other types of training as well. Training/calibration processor 242 can generate a trained or calibrated model 246 that is output by trained/calibrated model output system 244. The trained/calibrated model 246 may include modified coefficient values or a model trained or calibrated in other ways. The trained/calibrated model 246 can be output to one or more agricultural harvesters 102, 104 for use by the on-board yield sensors.

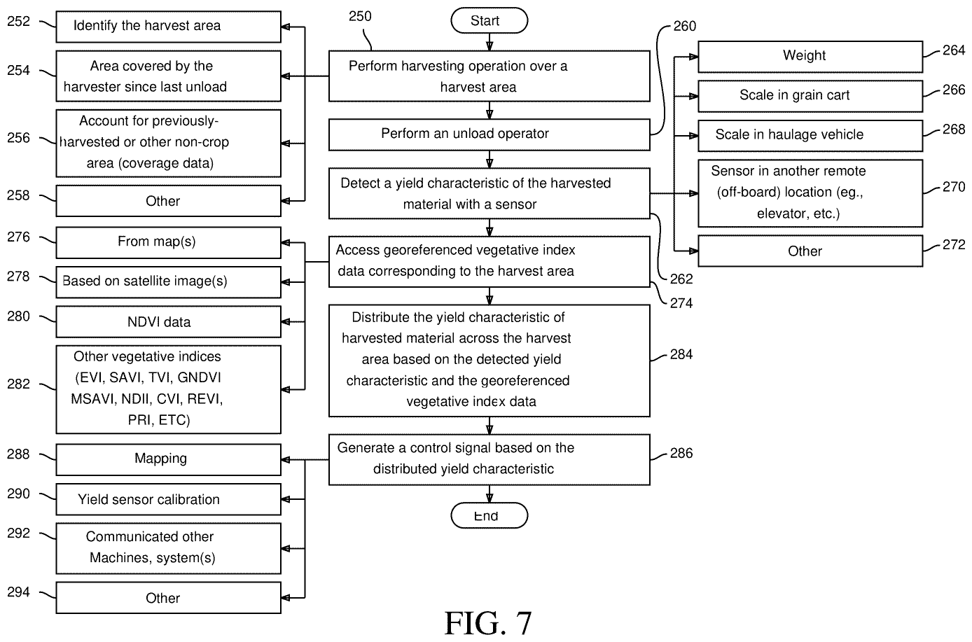

FIG. 7 is a flow diagram showing one example of the operation of yield characteristic distribution and control system 148. It is first assumed that an agricultural harvester performs a harvesting operation over a harvest area. For purposes of the present discussion, it will be assumed that agricultural harvester 102 has performed a harvesting operation over harvest area 132. Performing such an operation is indicated by block 250 in the flow diagram of FIG. 7. In one example, agricultural harvester 102 also identifies the harvest area 132, such as using a GNSS receiver, or in other ways, as indicated by block 252. The harvest area corresponds to the area covered by the agricultural harvester 102 since a last unload operation, as indicated by block 254. Also, in one example, agricultural harvester 102 accounts for non-crop areas over which harvester 102 traveled in the harvest area 132, such as areas that were already harvested or other non-crop areas, as indicated by block 256. Previously harvested areas may be accounted for using a coverage map or other coverage data, using a perception sensor, or in other ways. The harvesting operation can be performed, and the harvest area can be identified in other ways as well, as indicated by block 258.

Agricultural harvester 102 then performs an unload operation to unload harvested material into grain cart 112. Performing an unload operation is indicated by block 260 in the flow diagram of FIG. 7. A yield characteristic of the harvested material is then detected with a sensor, as indicated by block 262 in the flow diagram of FIG. 7. The sensed yield characteristic is a collective yield characteristic or overall yield characteristic that corresponds to the quantity of unloaded harvested material. In one example, the yield characteristic is weight 264 that may be detected by a scale in grain cart 144, as indicated by block 266. In another example, the weight of the harvested material is detected using a scale 146 in haulage vehicle 114, as indicated by block 268 in the flow diagram of FIG. 7. The weight or other yield characteristic can be detected using a sensor in another remote location that is remote from agricultural harvester 102. For instance, such a sensor may be located at an elevator or another destination to which haulage vehicle 114 carries the harvested material. Sensing the weight or other yield characteristic with another remote sensor is indicated by block 270 in the flow diagram of FIG. 7. The yield characteristic can be detected in other ways as well, as indicated by block 272.

Data store interaction system 214 then accesses geo-referenced vegetative index data 194 corresponding to the harvest area, as indicated by block 274 in the flow diagram of FIG. 7. The vegetative index data may be from maps 196, as indicated by block 276. The vegetative index data may be generated from satellite images or other images 198, as indicated by block 278. The vegetative index data may be normalized difference vegetative index data (NDVI), enhanced vegetative index data (EVI), soil adjusted vegetative index data (SAVI), transformed vegetative index data (TVI), green NDVI data (GNDVI), modified SAVI data (MSAVI), normalize difference infrared index data (NDII), chlorophyll vegetative index data (CVI), red edge vegetation index (REVI), photochemical reflectance image data (PRI), etc. these and other types of vegetative index data are represented by block 282 in the flow diagram of FIG. 7.

Yield characteristic distribution processor 222 then distributes the collective or overall yield characteristic (e.g., the weight) of harvested material across the harvest area based upon the detected yield characteristic (e.g., based on the weight) and the geo-referenced vegetative index data. Making such a distribution is indicated by block 284 in the flow diagram of FIG. 7.

Control signal generator 182 can then generate a control signal based upon the distributed yield characteristic, as indicated by block 286. The control signal can be used to perform mapping 288, yield sensor calibration 290, to control communication system 170 to communicate the distributed data to other machines 160 or other systems 162, as indicated by block 292, or to perform other control operations as indicated by block 294.

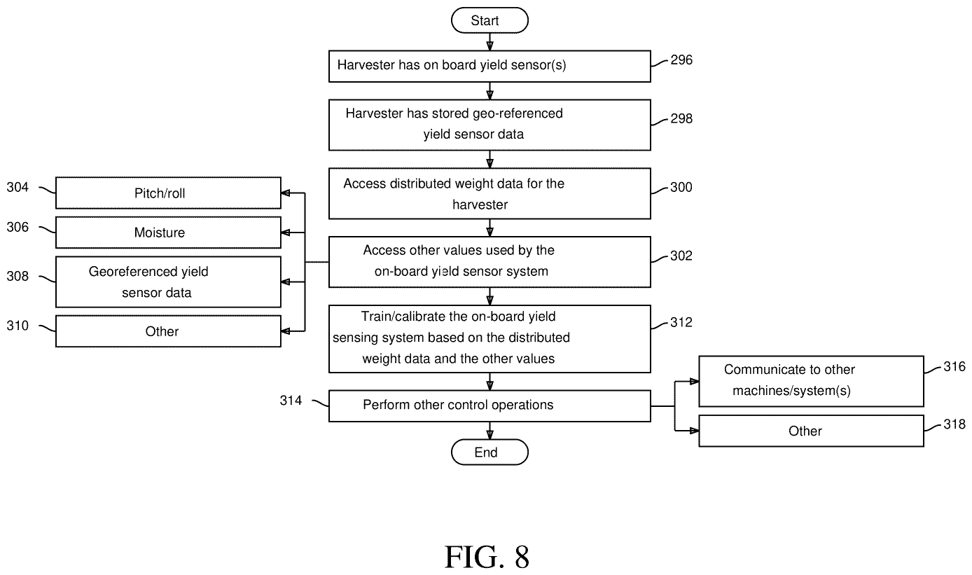

FIG. 8 is a flow diagram illustrating one example of the operation of calibration system 176 in more detail. It is first assumed that agricultural harvester 102 has an on-board yield sensor, as indicated by block 296 in the flow diagram of FIG. 8. It is also assumed that harvester 102 has stored geo-referenced yield sensor data (such as the mass flow data discussed above with respect to FIG. 5) for a harvest area, as indicated by block 298. Distribution data accessing system 238 then accesses the distributed weight data for the harvester 102, as indicated by block 300. Recall that the distributed data may be generated by distribution output system 224 in the form of a yield map, or in other forms.

Other value accessing system 240 accesses the other value data 202 that is used by the on-board yield sensing system to generate an output indicative of sensed yield. Accessing the other values 202 is indicated by block 302 and the flow diagram of FIG. 8. The other data that is used to generate an output indicative of sensed yield can include one or more of pitch and roll data 304, moisture data 306, geo-referenced yield sensor data 308, and/or any of a wide variety of other data 310.

Training/calibration processor 242 then trains and/or calibrates the on-board yield sensing system based upon the distributed weight data and the other values, as indicated by block 312 in the flow diagram of FIG. 8. Training/calibration processor 242 can provide outputs to trained/calibrated model output system 244 which are used to output a trained/calibrated model 246. The model 246 may be a regression model, an artificial intelligence model, a large language model, a rules-based or algorithm-based model, or another model that takes, as one or more inputs, a sensed or detected characteristic indicative of yield and generates an output that identifies yield, based upon those inputs.

Control signal generator 182 can perform other control operations based upon the calibrated model 246, as indicated by block 314. For instance, control signal generator 182 can control communication system 170 to communicate the trained/calibrated model 246 to other machines 160, other systems 162, etc., as indicated by block 316 and the flow diagram of FIG. 8. Calibration system 176 can perform other control operations as well, as indicated by block 318.

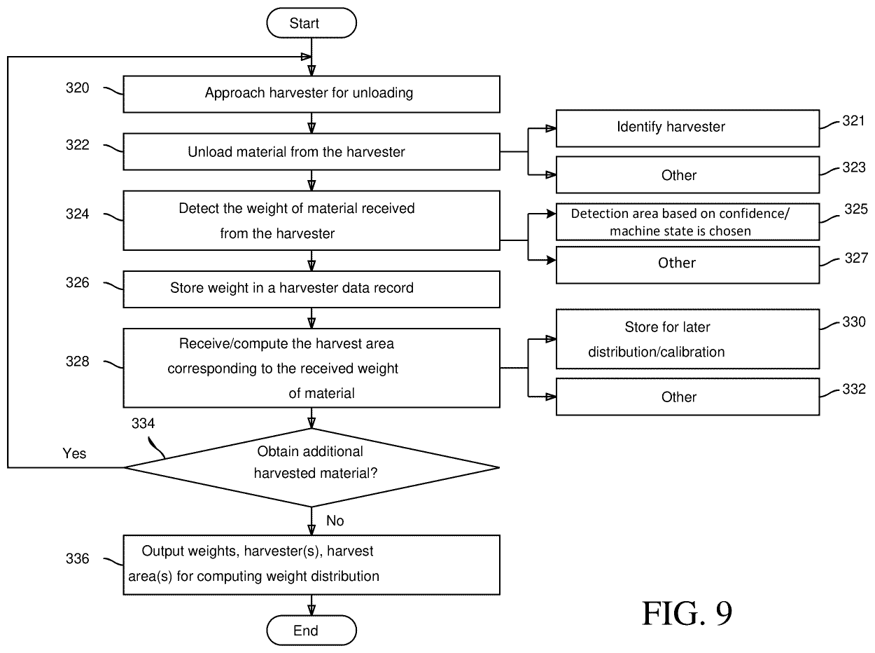

FIG. 9 is a flow diagram showing one example in which yield characteristic aggregation system 174 obtains harvested material from multiple harvesters or obtains harvested material from the same harvester during multiple unload operations, before unloading at haulage vehicle 114. It will be noted that the description of FIG. 9 can just as easily be applied where a haulage vehicle 114 includes scale 146 and receives harvested material from multiple material transfer vehicles 108. The description is provided in the context of material transfer vehicle 108 receiving harvested material from multiple agricultural harvesters 102, 104 for the sake of example only.

Material transfer vehicle 108 first approaches harvester 102 for unloading, as indicated by block 320 in the flow diagram of FIG. 9. The agricultural harvester 102 then unloads material into grain cart 112, as indicated by block 322. Harvester identifier 228 can identify the harvester 102. The identity of the harvester can be transmitted from harvester 102 itself or can be obtained in other ways. Identifying the harvester is indicated by block 321. Other information can be obtained from harvester 102 as well, as indicated by block 323.

Scale 144 detects the weight of material received from the first agricultural harvester 102, as indicated by block 324. Yield characteristic aggregation system 232 stores that weight in a harvester data record 186, as indicated by block 326. Also, there may be scenarios where the confidence in the detected weight value varies for different reasons. For instance, if the material transfer vehicle 108 is loaded by a harvester 102 on a sidehill, or on sloping terrain, then the weight value measured by scale 144 on that terrain may be less accurate than if the weight value was measured on flat terrain. Similarly, if the weight is measured by scale 144 while material transfer vehicle 108 is moving, that weight value may be less accurate than a weight value that is measured when material transfer vehicle 108 is stationary. Thus, in one example, the place or vehicle state where the weight of harvested material transferred to material transfer vehicle 108 is measured may be selected based on the confidence in the measured weight value, as indicated by block 325 in FIG. 9. The output from scale 144 may be read when material transfer vehicle 108 is on flat terrain, when material transfer vehicle 108 is stationary, or under other conditions where the confidence in the measured weight value is higher than at other locations or under other conditions. The weight can be detected in other ways 327 as well.

Harvest area identifier 234 then obtains the harvest area corresponding to the weight of material that has been unloaded from agricultural harvester 102 into grain cart 112. The harvest area (or data indicative of the harvest area-from which the harvest area can be computed) can be received from the agricultural harvester 102 or data indicative of the harvest area can be computed based upon location information received from the harvester 102 or obtained in other ways. Receiving or computing the harvest area corresponding to the received weight of harvested material is indicated by block 328 in the flow diagram of FIG. 9. The harvest area can be stored in a harvest data record 186 for later distribution and/or calibration, as indicated by block 330. The harvest area can be obtained and/or stored in other ways as well, as indicated by block 332.

If material transfer vehicle 108 is to obtain additional harvested material from any other harvesters (such as agricultural harvester 104), or if material transfer vehicle 108 is to wait and obtain additional harvested material from harvester 102 during a subsequent unload operation before unloading at haulage vehicle 114, as determined at block 334, then processing reverts to block 320 where the material transfer vehicle 108 approaches the harvester 102, 104 for the additional harvested material. A harvest data record 186 can then be generated for the additional harvested material received from harvester 102, 104.

If material transfer vehicle 108 is not to obtain additional harvested material from any other harvesters or to obtain additional harvested material from harvester 102 during a subsequent unload operation before unloading into haulage vehicle 104, then yield characteristic/harvest area output system 230 can output the weight, the identity of the harvesters from which material was received, the harvest areas corresponding to that weight, and/or other information either directly to distribution system 172 or for storage in data store 168, or in other ways. Outputting the weight, harvesters, harvest areas, etc., is indicated by block 336 and the flow diagram of FIG. 9.

It can thus be seen that the present description describes a system that uses a highly accurate measurement indicative of yield (e.g., a yield characteristic such as weight) as well as vegetative index values to accurately distribute the yield characteristic across a geographic area. The distributed yield characteristic can then be used to calibrate an on-board yield sensor, to generate a yield map, to display a yield characteristic or map on a user interface, or to perform other operations.

The present discussion has mentioned processors and servers. In one example, the processors and servers include computer processors with associated memory and timing circuitry, not separately shown. The processors and servers are functional parts of the systems or devices to which they belong and are activated by and facilitate the functionality of the other components or items in those systems.

It will be noted that the above discussion may have described a variety of different systems, components, models, generators, algorithms, sensors, identifiers, and/or logic. It will be appreciated that such systems, components, models, generators, algorithms, sensors, identifiers, and/or logic can be comprised of hardware items (such as processors and associated memory, or other processing components, some of which are described below) that perform the functions associated with those systems, components, models, generators, algorithms, sensors, identifiers, and/or logic. In addition, the systems, components, models, generators, algorithms, sensors, and/or logic can be comprised of software that is loaded into a memory and is subsequently executed by a processor or server, or other computing component, as described below. The systems, components, models, algorithms, sensors, generators, identifiers, and/or logic can also be comprised of different combinations of hardware, software, firmware, etc., some examples of which are described below. These are merely some examples of different structures that can be used to form the systems, components, models, algorithms, sensors, generators, identifiers, and/or logic described above. Other structures can be used as well.

Also, a number of user interface (UI) displays have been discussed. The UI can take a wide variety of different forms and can have a wide variety of different user actuatable input mechanisms disposed thereon. For instance, the user actuatable input mechanisms can be text boxes, check boxes, icons, links, drop-down menus, search boxes, etc. The mechanisms can also be actuated in a wide variety of different ways. For instance, they can be actuated using a point and click device (such as a track ball or mouse). The mechanisms can be actuated using hardware buttons, switches, a joystick or keyboard, thumb switches or thumb pads, etc. The mechanisms can also be actuated using a virtual keyboard or other virtual actuators. In addition, where the screen on which they are displayed is a touch sensitive screen, the mechanisms can be actuated using touch gestures. Also, where the device that displays the mechanisms has speech recognition components, the mechanisms can be actuated using speech commands.

A number of data stores have also been discussed. It will be noted the data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

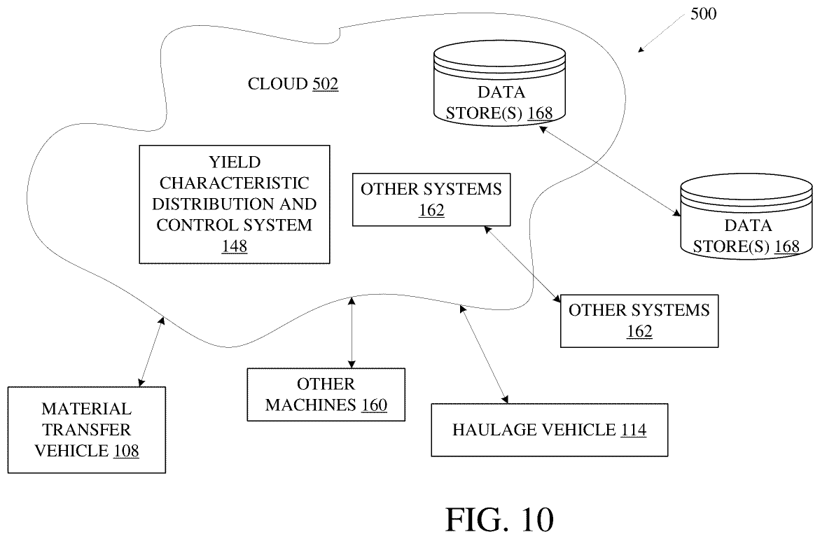

FIG. 10 is a block diagram of the architecture, shown in other FIGs., except that some elements are disposed in a remote server architecture 500. In an example, remote server architecture 500 can provide computation, software, data access, and storage services that do not require end-user knowledge of the physical location or configuration of the system that delivers the services. In various examples, remote servers can deliver services over a wide area network, such as the internet, using appropriate protocols. For instance, remote servers can deliver applications over a wide area network, and they can be accessed through a web browser or any other computing component. Software or components shown in other FIGs. as well as the corresponding data, can be stored on servers at a remote location. The computing resources in a remote server environment can be consolidated at a remote data center location or they can be dispersed. Remote server infrastructures can deliver services through shared data centers, even though they appear as a single point of access for the user. Thus, the components and functions described herein can be provided from a remote server at a remote location using a remote server architecture. Alternatively, the components and functions can be provided from a conventional server, or they can be installed on client devices directly, or in other ways.

In the example shown in FIG. 10, some items are similar to those shown in FIGS. 1-9 and they are similarly numbered. FIG. 10 specifically shows that some yield characteristic distribution and control system 148 and data store 168, or other systems 162, can be located at a remote server location 502. Therefore, parts of system 148 can access those systems through remote server location 502. FIG. 10 also shows that other machines 160 and/or other systems 162 can communicate with remote server environment 502.

FIG. 10 also depicts another example of a remote server architecture. FIG. 10 shows that it is also contemplated that some elements of other FIGS. can be disposed at remote server location 500 while others are not. By way of example, data store 168 can be disposed at a location separate from location 500 and accessed through the remote server at location 500. Regardless of where the elements are located, the elements can be accessed directly by system 148 or other systems, through a network (either a wide area network or a local area network), the elements can be hosted at a remote site by a service, or the elements can be provided as a service, or accessed by a connection service that resides in a remote location. Also, the data can be stored in substantially any location and intermittently accessed by, or forwarded to, interested parties. For instance, physical carriers can be used instead of, or in addition to, electromagnetic wave carriers. In such an example, where cell coverage is poor or nonexistent, another mobile machine (such as a fuel truck) can have an automated information collection system. As the tractor or harvester comes close to the fuel truck for fueling, the system automatically collects the information from the tractor or harvester using any type of ad-hoc wireless connection. The collected information can then be forwarded to the main network as the fuel truck reaches a location where there is cellular coverage (or other wireless coverage). For instance, the fuel truck may enter a covered location when traveling to fuel other machines or when at a main fuel storage location. All of these architectures are contemplated herein. Further, the information can be stored on tractor or harvester until the tractor or harvester enters a covered location. The tractor or harvester, itself, can then send the information to the main network.

It will also be noted that the elements of other FIGS., or portions of them, can be disposed on a wide variety of different devices. Some of those devices include servers, desktop computers, laptop computers, tablet computers, or other mobile devices, such as palm top computers, cell phones, smart phones, multimedia players, personal digital assistants, etc.

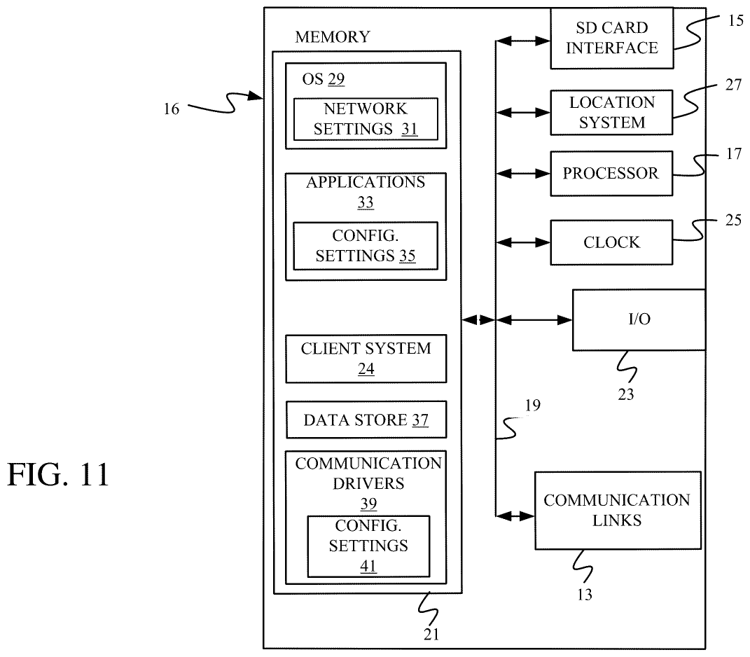

FIG. 11 is a simplified block diagram of one illustrative example of a handheld or mobile computing device that can be used as a user's or client's handheld device 16, in which the present system (or parts of it) can be deployed. For instance, a mobile device can be deployed in the operator compartment of tractor 110 or one of the harvesters 102, 104 for use in generating, processing, or displaying the distributed data. FIGS. 11-13 are examples of handheld or mobile devices.

FIG. 11 provides a general block diagram of the components of a client device 16 that can run some components shown in other FIGS., that interact with those components, or both. In device 16, a communications link 13 is provided that allows the handheld device to communicate with other computing devices and in some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors from previous FIGS.) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a GNSS, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

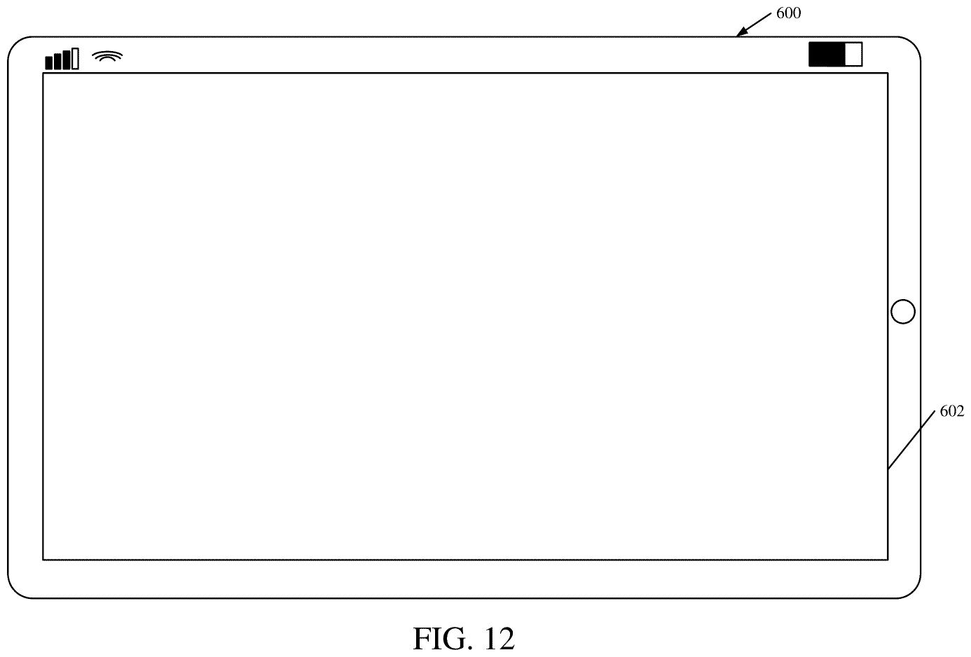

FIG. 12 shows one example in which device 16 is a tablet computer 600. In FIG. 12, computer 600 is shown with user interface display screen 602. Screen 602 can be a touch screen or a pen-enabled interface that receives inputs from a pen or stylus. Computer 600 can also use an on-screen virtual keyboard. Of course, computer 600 might also be attached to a keyboard or other user input device through a suitable attachment mechanism, such as a wireless link or USB port, for instance. Computer 600 can also illustratively receive voice input as well.

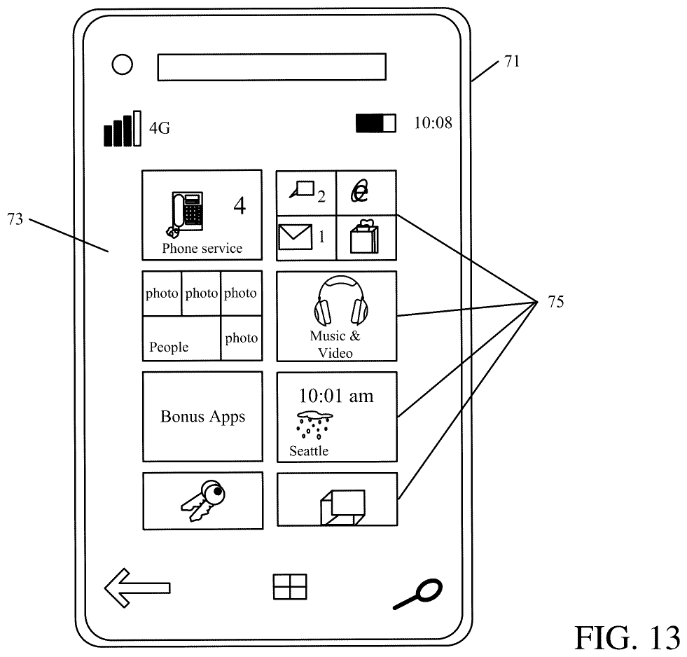

FIG. 13 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

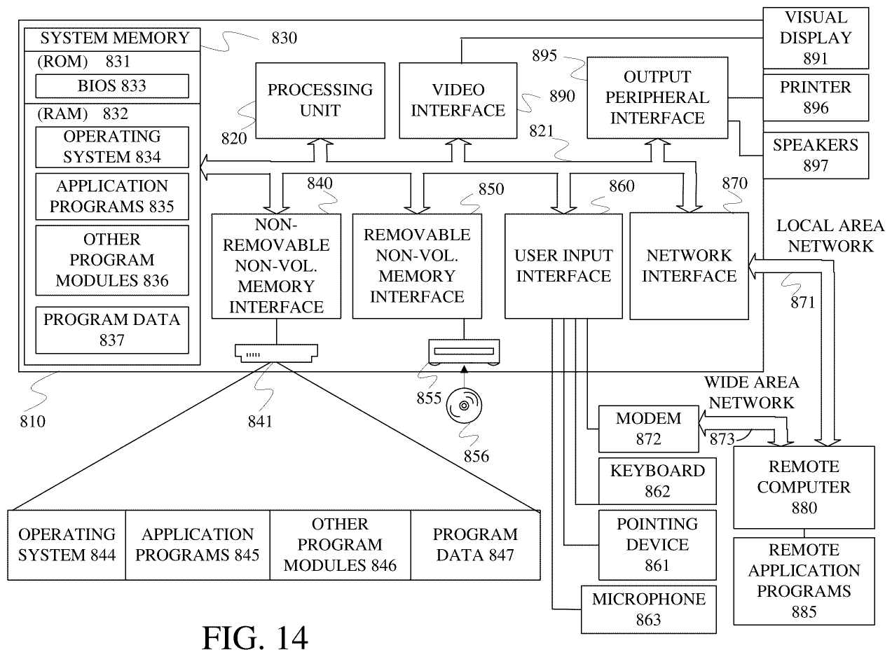

FIG. 14 is one example of a computing environment in which elements of other FIGs., or parts of it, (for example) can be deployed. With reference to FIG. 14, an example system for implementing some embodiments includes a computing device in the form of a computer 810 programmed to operate as described above. Components of computer 810 may include, but are not limited to, a processing unit 820 (which can comprise processors or servers from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. Memory and programs described with respect to other FIGS. can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from and does not include a modulated data signal or carrier wave. Computer storage media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information, and which can be accessed by computer 810. Communication media may embody computer readable instructions, data structures, program modules or other data in a transport mechanism and includes any information delivery media. The term “modulated data signal” means a signal that has one or more of its characteristics set or changed in such a manner as to encode information in the signal.

System memory 830 includes computer storage media in the form of volatile and/or nonvolatile memory such as read only memory (ROM) 831 and random-access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, an optical disk drive 855, and nonvolatile optical disk 856. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus but may be connected by other interface and bus structures. A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections (such as a controller area network—CAN, local area network—LAN, or wide area network WAN) to one or more remote computers, such as a remote computer 880.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. In a networked environment, program modules may be stored in a remote memory storage device. FIG. 14 illustrates, for example, that remote application programs 885 can reside on remote computer 880.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method comprising:
detecting a collective yield characteristic indicative of crop yield corresponding to harvested material received from an agricultural harvester;
obtaining harvest area indicia indicative of a harvest area from which the harvested material was harvested;
accessing geo-referenced agricultural characteristic index data corresponding to the harvest area; and
attributing portions of the collective yield characteristic to a plurality of different geographic locations in the harvest area based on the geo-referenced agricultural characteristic index data.

2. The computer implemented method of claim 1 and further comprising:
generating a control signal based on the attributed portions of the collective yield data.

3. The computer implemented method of claim 1, wherein detecting the collective yield characteristic comprises:
detecting an overall weight of the harvested material.

4. The computer implemented method of claim 3, wherein attributing portions of the collective yield characteristic comprises:
attributing portions of the overall weight of the harvested material to different geographic locations in the harvest area based on the geo-referenced agricultural characteristic index data.

5. The computer implemented method of claim 4 and further comprising:
receiving the harvested material from an agricultural harvester at a material transfer vehicle.

6. The computer implemented method of claim 5, wherein detecting an overall weight comprises:
detecting the overall weight of the harvested material with a scale disposed on the material transfer vehicle.

7. The computer implemented method of claim 5, wherein receiving the harvested material comprises:
receiving, at the material transfer vehicle, a first amount of harvested material from a first harvester; and
receiving, at the material transfer vehicle, a second amount of harvested material from a second harvester.

8. The computer implemented method of claim 7, wherein obtaining harvest area indicia comprises:
identifying a first harvest area from which the first amount of harvested material was harvested; and
identifying a second harvest area from which the second amount of harvested material was harvested.

9. The computer implemented method of claim 8, wherein accessing geo-referenced agricultural characteristic index data comprises:
accessing a first set of geo-referenced agricultural characteristic index data corresponding to the first harvest area; and
accessing a second set of geo-referenced agricultural characteristic index data corresponding to the second harvest area.

10. The computer implemented method of claim 9, wherein attributing portions of the collective yield characteristic comprises:
attributing the first amount of the harvested material to geographic locations in the first harvest area based on the first set of geo-referenced agricultural characteristic index data; and
attributing the second amount of the harvested material to geographic locations in the second harvest area based on the second set of geo-referenced agricultural characteristic index data.

11. The computer implemented method of claim 4 and further comprising:
receiving the harvested material at a haulage vehicle.

12. The computer implemented method of claim 11, wherein detecting the overall weight comprises:
detecting the overall weight of the harvested material with a scale on the haulage vehicle.

13. The computer implemented method of claim 2, wherein generating a control signal comprises:
generating a mapping signal to generate a yield map.

14. The computer implemented method of claim 2, wherein generating a control signal comprises:
generating a calibration signal to calibrate a yield sensor on the agricultural harvester.

15. A characteristic distribution system comprising:
a yield characteristic detector configured to detect a collective yield characteristic indicative of crop yield corresponding to harvested material harvested by an agricultural harvester;
a harvest area identifier configured to obtain harvest area indicia indicative of a harvest area from which the harvested material was harvested;
an agricultural characteristic index-to-harvested area correlation system configured to access geo-referenced agricultural characteristic index data and correlate the geo-referenced agricultural characteristic index data to the harvest area; and
a yield characteristic distribution processor configured to attribute portions of the collective yield characteristic to a plurality of different geographic locations in the harvest area based on the geo-referenced agricultural characteristic index data.

16. The characteristic distribution system of claim 15, wherein the yield characteristic detector comprises:
a scale configured to generate, as the collective yield characteristic, a weight indicator indicative of a weight of the harvested material.

17. The characteristic distribution system of claim 15 and further comprising:
a control signal generator configured to generate a control signal based on the attributed portions of the collective yield data.

18. The characteristic distribution system of claim 17, wherein the agricultural harvester includes an on-board yield sensing system configured to sense harvested material yield on the agricultural harvester, and wherein the control signal generator is configured to generate a calibration signal to calibrate the on-board yield sensing system.

19. An agricultural system comprising:
a scale configured to detect a collective material weight corresponding to harvested material received from an agricultural harvester; and
a distribution system configured to identify a harvest area from which the harvested material was harvested, access geo-referenced agricultural characteristic index data corresponding to the harvest area, and attribute portions of the collective material weight to a plurality of different geographic locations in the harvest area based on the geo-referenced agricultural characteristic index data.

20. The agricultural system of claim 19, wherein the agricultural harvester includes an on-board yield sensing system, and further comprising:
a calibration system configured to calibrate the on-board yield sensing system based on the attributed portions of the collective material weight.
